(19) United States
(12) Patent Application Publication
(10) Pub. No.: US 2022/0105748 A1
(43) Pub. Date: Apr. 7, 2022

(54) TRACTION CONTROL SYSTEM FOR VEHICLE

(71) Applicant: Volvo Truck Corporation, Göteborg (SE)

(72) Inventor: Kaveesha PURUSHOTHAMA, Bengaluru Karnataka (IN)

(21) Appl. No.: 17/426,895

(22) PCT Filed: Dec. 9, 2019
(86) PCT No.: PCT/EP2019/084244

§ 371 Date: Jul. 29, 2021

(30) Foreign Application Priority Data
Feb. 11, 2019 (IN) 201941005228

(51) Int. Cl. B60B 15/28

(52) U.S. Cl. CPC B60B 15/28

(57) ABSTRACT

The invention relates to a traction control system (11), for controlling a contact force (F) between a wheel (5) rotating around a wheel rotation axis (9) and a contact surface (6), the traction control system (11) comprising: at least a first weight (13a-c) controllable to move around the wheel rotation axis (9) when the traction control system (11) is coupled to the wheel (5); and a weight guiding arrangement (15) configured to guide the first weight (13a-c) in such a way that, when the first weight (13a-c) moves around the wheel rotation axis (9), a center of mass of the first weight (13a-c) follows a first path defined by the weight guiding arrangement (15), wherein the first path exhibits a first portion with a first radius (R₁) of curvature, and a second portion with a second radius (R₂) of curvature, larger than the first radius (R₁) of curvature.

### TECHNICAL FIELD

The invention relates to a traction control system for controlling a contact force between a wheel rotating around a wheel rotation axis and a contact surface, and to a vehicle comprising such a traction control system.

The invention can be applied in heavy-duty vehicles, such as trucks, buses and construction equipment. Although the invention will be described with respect to a truck, the invention is not restricted to this particular vehicle, but may also be used in other vehicles, for instance buses or various kinds of working vehicles, such as wheel loaders, excavators, or articulated haulers etc.

### BACKGROUND

The ability to effectively brake is essential for safe driving of any vehicle. Much development has been carried out to prevent the brakes from locking, and to increase the friction between the road and the tires. However, it would be desirable to provide for an improved braking capability of a vehicle.

### SUMMARY

An object of the invention is to provide for an improved braking capability of a vehicle.

According to a first aspect of the invention, this object is achieved by a traction control system, for controlling a contact force between a wheel rotating around a wheel rotation axis and a contact surface, the traction control system comprising: at least a first weight controllable to move around the wheel rotation axis when the traction control system is coupled to the wheel; and a weight guiding arrangement configured to guide the first weight in such a way that, when the first weight moves around the wheel rotation axis, a center of mass of the first weight follows a first path defined by the weight guiding arrangement, wherein the first path exhibits a first portion with a first radius of curvature, and a second portion with a second radius of curvature, larger than the first radius of curvature.

The first portion with the first radius of curvature and the second portion with the second radius of curvature may be angularly spaced apart by at least 90°, and advantageously by approximately 180°.

The present invention is based on the realization that the friction between tire and road can be increased by increasing the contact force between the tire and the road, and that this can be achieved by moving a weight around the wheel rotation axis in such a way that a net centrifugal force provided by the movement of the weight is directed towards the road. The present inventor has further realized that this can be achieved by means of a traction control system with a weight guiding arrangement configured to guide at least one weight along a path defining different radii of curvature in different segments of the path. A transition from a smaller radius of curvature to a larger radius of curvature will result in a transition to a larger centrifugal force, given that the angular speed of the weight is substantially constant.

According to various embodiments of the traction control system of the present invention, the weight guiding arrangement may comprise a first guiding member coupled to the first weight and arranged to rotate around the wheel rotation axis, when the traction control system is coupled to the wheel, the first guiding member defining the second portion of the path having the second radius of curvature; and a second guiding member, coupled to the first guiding member and to the first weight, and arranged to rotate, in response to the rotation of the first guiding member, around a weight rotation axis, parallel to and offset from the wheel rotation axis, the second guiding member defining the first portion of the path having the first radius of curvature.

The first weight may be coupled to the first guiding member in such a way that the first weight moves around the wheel rotation axis in response to the rotation of the first guiding member.

The first weight may be coupled to the first guiding member in such a way that the first weight is radially movable in relation to the first guiding member; and the first weight may be coupled to the second guiding member in such a way that the first weight is radially movable in relation to the second guiding member.

According to embodiments, the traction control system may comprises a second weight controllable to move around the wheel rotation axis when the traction control system is coupled to the wheel; and the weight guiding arrangement may be configured to guide the second weight in such a way that, when the second weight moves around the wheel rotation axis, a center of mass of the second weight follows a second path defined by the weight guiding arrangement, wherein the second path exhibits a first portion with a first radius of curvature, and a second portion with a second radius of curvature, greater than the first radius of curvature.

With additional weights, the desired higher contact force between tire and road can be achieved with a higher frequency, for a given rotational speed of the weights.

The first radius of curvature of the second path may be substantially equal to the first radius of curvature of the first path; and the second radius of curvature of the second path may be substantially equal to the second radius of curvature of the first path.

The second path of the center of mass of the second weight may be substantially identical to the first path of the center of mass of the first weight.

Where the traction control system comprises more than one weight, the weights comprised in the traction control system may advantageously be substantially evenly angularly distributed around the wheel rotation axis.

According to embodiments, the traction control system may comprise a first weight, a second weight and a third weight; and the weight guiding arrangement may comprise: a first guiding member arranged to rotate around the wheel rotation axis, the first guiding member comprising a first radially extending slit accommodating the first weight, restricting the first weight to move along the first radially extending slit, and defining a first maximum distance between the wheel rotation axis and the first weight; a second radially extending slit accommodating the second weight, restricting the second weight to move along the second radially extending slit, and defining a second maximum distance between the wheel rotation axis and the second weight; and a third radially extending slit accommodating the third weight, restricting the third weight to move along the third radially extending slit, and defining a third maximum distance between the wheel rotation axis and the third weight; and a second guiding member arranged to rotate around a weight rotation axis, parallel to and offset from the wheel rotation axis. The first weight may be coupled to the second guiding member to rotate at a first maximum distance from the weight rotation axis, the second weight may be coupled to the second guiding member to rotate at a second maximum distance from the weight rotation axis, and the third weight may be coupled to the second guiding member to rotate at a third maximum distance from the weight rotation axis.

The traction control system according to embodiments of the present invention may advantageously be included in a vehicle, further comprising a vehicle body; and a wheel arranged to rotate around a wheel rotation axis in relation to the vehicle body while being in contact with a contact surface. The traction control system may be controllable to be coupled to the wheel in such a way that the at least first weight of the traction control system moves around the wheel rotation axis.

Advantageously, the first path defined by the weight guiding arrangement comprised in the traction control system may exhibit the second radius of curvature between the wheel rotation axis and the contact surface, and the first radius of curvature further away from the contact surface than the wheel rotation axis.

According to embodiments, the vehicle may comprise a coupling controllable to couple the traction control system to the wheel in such a way that the at least first weight moves around the wheel rotation axis in response to rotation of the wheel around the wheel rotation axis.

The vehicle may further comprise a braking system operable to apply a retardation torque to the wheel in response to a braking request; and the coupling may be configured to couple the traction control system to the wheel in response to the braking request.

According to a second aspect of the present invention, there is provided a method of controlling the vehicle according to embodiments of the present invention, comprising the steps of: receiving a braking request; and controlling the coupling to couple the traction control system to the wheel in response to the braking request.

According to a third aspect of the invention, there is provided a computer program configured to, when run on a processor comprised in the vehicle according to embodiments of the present invention, cause the processor to carry out the steps of the method according to embodiments of the present invention.

### BRIEF DESCRIPTION OF THE DRAWINGS

With reference to the appended drawings, below follows a more detailed description of embodiments of the invention cited as examples.

In the drawings:

FIG. 1 is a side view of a vehicle according to an embodiment of the present invention, in the form of a truck having a traction control system according to an embodiment of the invention.

FIG. 2 is an exploded schematic illustration of a traction control system according to an example embodiment of the invention.

FIGS. 3A-C schematically illustrate operation of the traction control system in FIG. 2.

FIG. 4 is a block diagram schematically illustrating control of the braking system and the traction control system of the vehicle in FIG. 1.

FIG. 5 is a flow-chart schematically illustrating an example embodiment of the method according to the present invention.

### DETAILED DESCRIPTION OF EXAMPLE EMBODIMENTS OF THE INVENTION

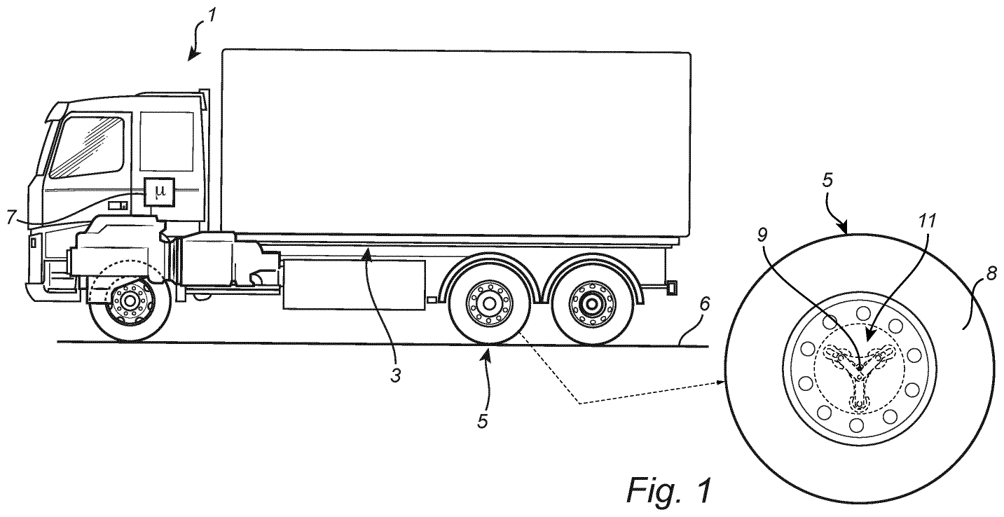

FIG. 1 schematically shows a vehicle, here in the form of a truck 1, comprising a body 3 and wheels 5 arranged to rotate around a wheel rotation axis 9 in relation to the vehicle body, while being in contact with a contact surface 6. The vehicle 1 comprises a control unit 7 that is configured to at least control operation of the braking system of the vehicle 1 in response to a braking request.

As is schematically indicated in FIG. 1, the vehicle further comprises a traction control system 11 according to an example embodiment of the present invention. The traction control system 11 is controllable, by the control unit 7, to be coupled to the wheel 5 to increase traction between the tire 8 of the wheel 5 and the contact surface 6. How this increased traction may be achieved will be described in greater detail further below.

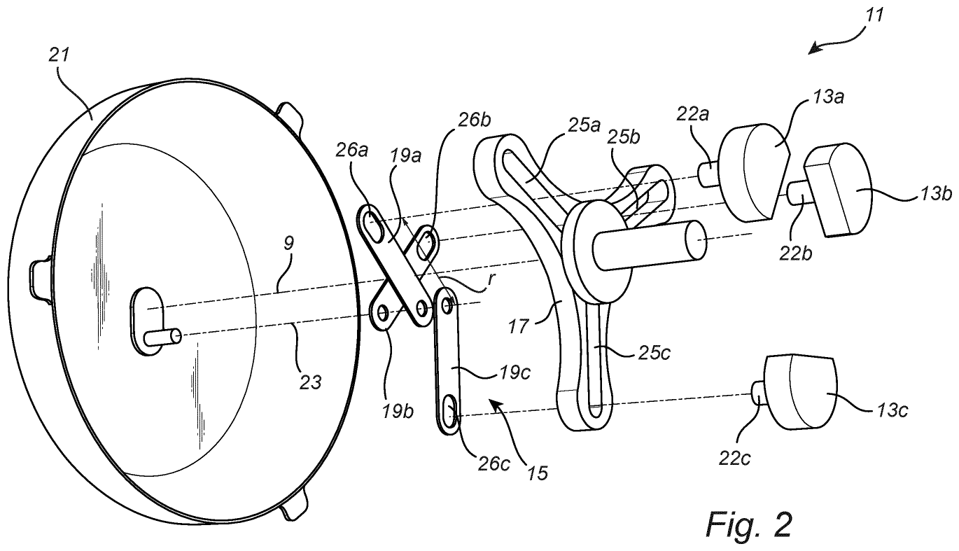

FIG. 2 is an exploded schematic illustration of the traction control system 11 according to an example embodiment of the invention. Referring to FIG. 2, the traction control system 11 comprises a solid first weight 13a, a solid second weight 13b, and a solid third weight 13c, a weight guiding arrangement 15, to which the weights 13a-c are coupled, and a housing 21.

The weight guiding arrangement 15 comprises a first guiding member 17, and second guiding members 19a-c. The first guiding member 17 is arranged to rotate around the wheel rotation axis 9, when installed in a vehicle 1, and each of the second guiding members 19a-c is arranged to rotate around a weight rotation axis 23, which is parallel to and offset from the wheel rotation axis 9, as is schematically indicated in FIG. 2.

The first guiding member 17 is provided with first 25a, second 25b and third 25c radially extending slits, and each of the second guiding members 19a-c has respective elongated holes 26a-c. As is schematically indicated in FIG. 2, each of the weights 13a-c is coupled to the first guiding member 17 and its respective second guiding member 19a-c by means of a guiding pin 22a-c that is accommodated by both a respective slit 25a-c of the first guiding member and an elongated hole 26a-c of its respective second guiding member 19a-c.

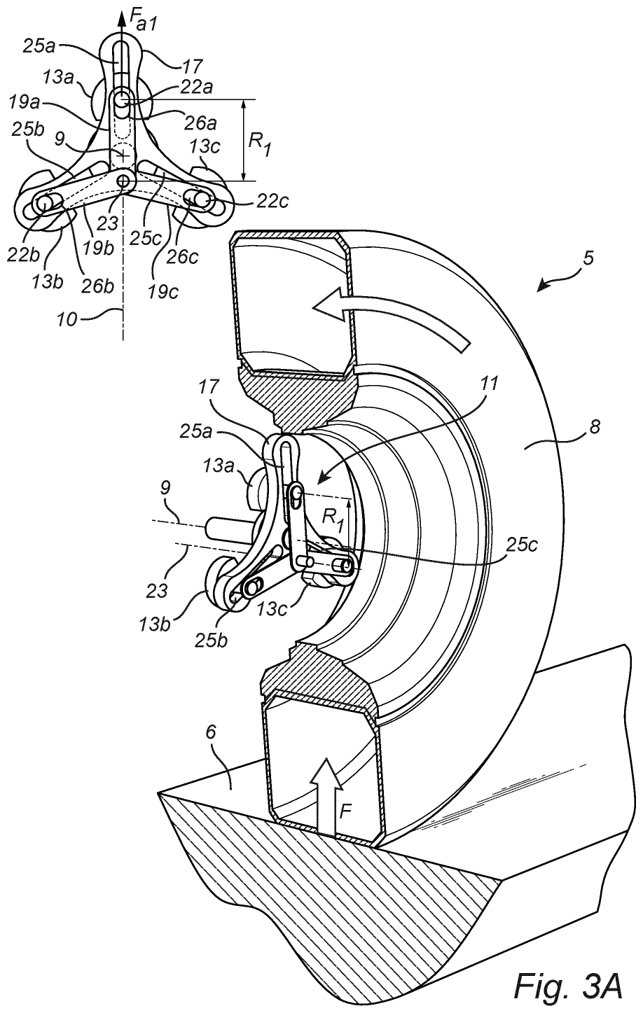

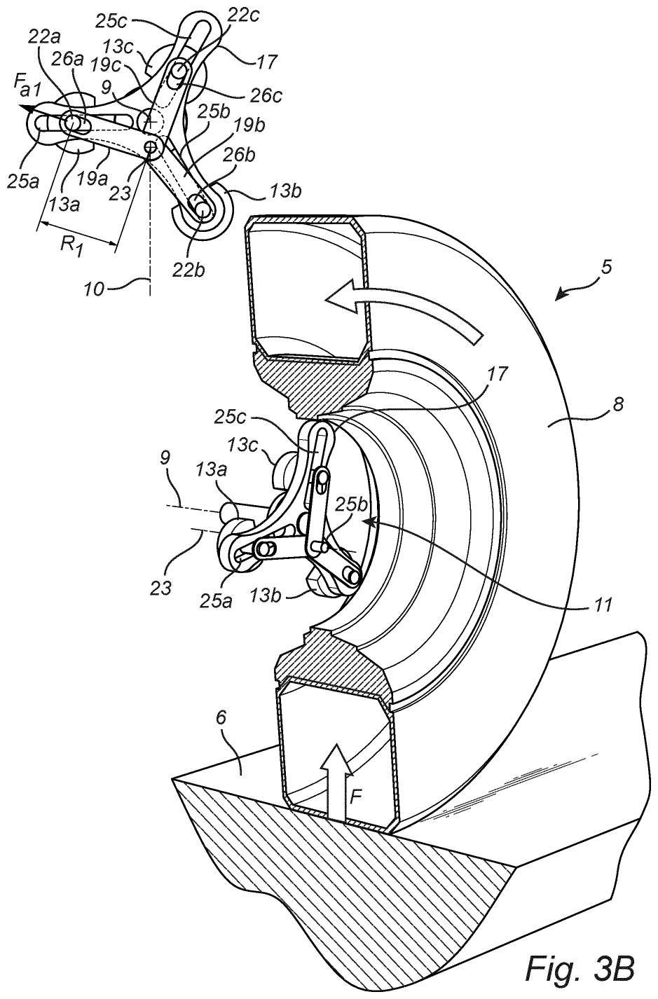

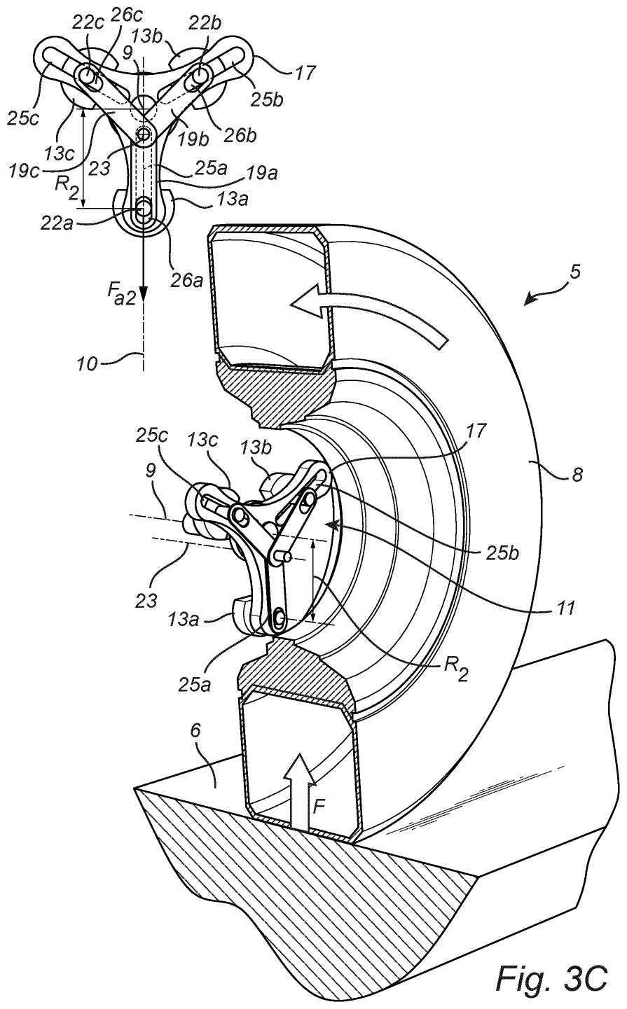

As will be apparent from the continued description below with reference to FIGS. 3A-C, the first guiding member 17 and the second guiding members 19a-c are configured to guide the weights 13a-c along a path in which each weight experiences a rather sudden transition from a first radius R₁ to a second radius R₂, larger than the first radius R₁.

In FIGS. 3A-C, the first weight 13a will be followed around a half revolution (180°) of the traction control system 11. It should be noted that this may correspond to a half revolution of the wheel 5, or that there may be some gear ratio between the rotation of the wheel 5 and the rotation of the traction control system 11. In the latter case, the traction control system 11 may, for example, be controlled to rotate faster than the wheel 5.

Referring first to FIG. 3A, the first weight 13a is shown to be in a first angular position in relation to the wheel rotation axis 9, which is 0° in relation to a vertical line 10 passing through the wheel rotation axis 9. In this first angular position, the first weight 13a is moving with a first angular speed ω₁ along a path defined by a first radius of curvature R₁. As is schematically shown in FIG. 3A, the first radius of curvature R₁ is determined by the second guiding member 19a associated with the first weight 13a, and the weight rotation axis 23 is the center of rotation of the first weight 13a. This means that the current centrifugal force provided by the first weight 13a is Fₐ₁=mω₁²R₁, where m is the mass of the first weight 13a.

In FIG. 3B, the first weight 13a is shown to have moved 90° counter-clockwise in relation to the wheel rotation axis 9 (the first weight 13a has moved a slightly smaller angular distance in relation to the weight rotation axis 23) to be in a second angular position in relation to the wheel rotation axis 9 (90° in relation to the vertical line 10 passing through the wheel rotation axis 9). In this second angular position, the first weight 13a is still moving with the first angular speed ω₁ along a path defined by a first radius of curvature R₁. Accordingly, the current centrifugal force provided by the first weight 13a is still Fₐ₁.

In FIG. 3C, the first weight 13a is shown to have moved 180° counter-clockwise in relation to the wheel rotation axis 9 to be in a third angular position in relation to the wheel rotation axis 9 (180° in relation to the vertical line 10 passing through the wheel rotation axis 9). In this third angular position, the first weight 13a is moving with a second angular speed w₂ along a path defined by a second radius of curvature R₂. Thanks to the elongated hole 26a of the second guiding member 19a and the dimensioning of the first radially extending slit 25a of the first guiding member 17, the second radius of curvature R₂ is determined by the first radially extending slit 25a of the first guiding member 17, and the wheel rotation axis 9 is the center of rotation of the first weight 13a. This means that the current centrifugal force provided by the first weight 13a is now Fₐ₂=mω₂²R₂.

Since the second angular speed ω₂ of the first weight 13a in the third angular position is only slightly lower than the first angular speed ω₁ of the first weight 13a in the first angular position, and the second radius of curvature R₂ is considerably larger than the first radius of curvature R₁ (R₂−R₁=distance between the wheel rotation axis 9 and the weight rotation axis 23), the centrifugal force Fₐ₂ provided by the first weight 13a when in the third position is larger than the centrifugal force Fₐ₁ provided by the first weight 13a when in the first position. This means that the traction control system 11 provides a net centrifugal force directed downwards in FIGS. 3A-C, when the traction control system is controlled to rotate around the wheel rotation axis 9.

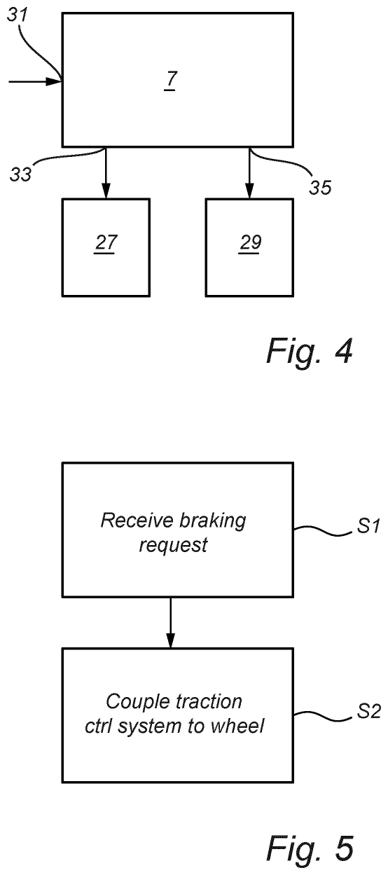

FIG. 4 is a block diagram schematically illustrating control of the braking system and the traction control system of the vehicle in FIG. 1. Referring to FIG. 4, the control unit 7 of the vehicle 1 comprises an input 31 for receiving a braking request, a first output 33 coupled to the braking system 27 of the vehicle 1, and a second output 35 coupled to a coupling 29 controllable to couple the traction control system 11 to the wheel 5 of the vehicle 1 in such a way that the at least first weight 13a-c moves around the wheel rotation axis 9 in response to rotation of the wheel 5 around the wheel rotation axis 9.

FIG. 5 is a flow-chart schematically illustrating an example embodiment of the method according to the present invention. In a first step S1, the control unit 7 receives a braking request at the input 31. In the subsequent step S2, the control unit 7 provides a braking system control signal to the first output 33 to control the braking system to apply a retardation torque to the wheel 5, and a traction control system control signal to the second output 35 to control the coupling 29 to couple the traction control system 11 to the wheel 5 as described above with reference to FIGS. 3A-C, in response to the braking request.

It is to be understood that the present invention is not limited to the embodiments described above and illustrated in the drawings; rather, the skilled person will recognize that many changes and modifications may be made within the scope of the appended claims. For example, the traction control system 11 may comprise another number of weights than three, such as a larger number of weights. Furthermore, the weight guiding arrangement may be configured in other ways, as long as the functionality is fulfilled of transitioning the path of the weight(s) between a first radius of curvature and a second radius of curvature that is larger than the first radius of curvature.

1. A traction control system, for controlling a contact force between a wheel rotating around a wheel rotation axis and a contact surface, the traction control system comprising:
at least a first weight controllable to move around the wheel rotation axis when the traction control system is coupled to the wheel; and
a weight guiding arrangement configured to guide the first weight in such a way that, when the first weight moves around the wheel rotation axis, a center of mass of the first weight follows a first path defined by the weight guiding arrangement, wherein the first path exhibits a first portion with a first radius of curvature, and a second portion with a second radius of curvature, larger than the first radius of curvature.

2. The traction control system of claim 1, wherein the weight guiding arrangement comprises:
a first guiding member coupled to the first weight and arranged to rotate around the wheel rotation axis when the traction control system is coupled to the wheel (5), the first guiding member defining the second portion of the path having the second radius of curvature; and
a second guiding member (19a-c), coupled to the first guiding member and to the first weight, and arranged to rotate, in response to the rotation of the first guiding member, around a weight rotation axis, parallel to and offset from the wheel rotation axis, the second guiding member defining the first portion of the path having the first radius of curvature.

3. The traction control system of claim 2, wherein the first weight is coupled to the first guiding member in such a way that the first weight moves around the wheel rotation axis in response to the rotation of the first guiding member.

4. The traction control system of claim 2, wherein:
the first weight is coupled to the first guiding member in such a way that the first weight is radially movable in relation to the first guiding member; and
the first weight is coupled to the second guiding member in such a way that the first weight is radially movable in relation to the second guiding member.

5. The traction control system of claim 1, wherein:
the traction control system comprises a second weight controllable to move around the wheel rotation axis when the traction control system is coupled to the wheel; and
the weight guiding arrangement is configured to guide the second weight in such a way that, when the second weight moves around the wheel rotation axis, a center of mass of the second weight follows a second path defined by the weight guiding arrangement, wherein the second path exhibits a first portion with a first radius of curvature, and a second portion with a second radius of curvature, greater than the first radius of curvature.

6. The traction control system of claim 5, wherein:
the first radius of curvature of the second path is substantially equal to the first radius of curvature of the first path; and
the second radius of curvature of the second path is substantially equal to the second radius of curvature of the first path.

7. The traction control system of claim 6, wherein the second path of the center of mass of the second weight is substantially identical to the first path of the center of mass of the first weight.

8. The traction control system of claim 6, wherein the weights comprised in the traction control system are evenly angularly distributed around the wheel rotation axis.

9. The traction control system of claim 1, wherein:
the traction control system comprises a first weight, a second weight and a third weight;
the weight guiding arrangement comprises:
a first guiding member arranged to rotate around the wheel rotation axis, the first guiding member comprising:
a first radially extending slit accommodating the first weight, restricting the first weight to move along the first radially extending slit, and defining a first maximum distance between the wheel rotation axis and the first weight;
a second radially extending slit accommodating the second weight, restricting the second weight to move along the second radially extending slit, and defining a second maximum distance between the wheel rotation axis and the second weight; and
a third radially extending slit accommodating the third weight, restricting the third weight to move along the third radially extending slit, and defining a third maximum distance between the wheel rotation axis and the third weight; and
a second guiding member arranged to rotate around a weight rotation axis, parallel to and offset from the wheel rotation axis,
wherein the first weight is coupled to the second guiding member to rotate at a first maximum distance from the weight rotation axis, the second weight is coupled to the second guiding member to rotate at a second maximum distance from the weight rotation axis, and the third weight is coupled to the second guiding member to rotate at a third maximum distance from the weight rotation axis.

10. A vehicle comprising:
a vehicle body;
a wheel arranged to rotate around a wheel rotation axis in relation to the vehicle body while being in contact with a contact surface; and
a traction control system for controlling a contact force between a wheel rotating around a wheel rotation axis and a contact surface, the traction control system comprising:
at least a first weight controllable to move around the wheel rotation axis when the traction control system is coupled to the wheel; and
a weight guiding arrangement configured to guide the first weight in such a way that, when the first weight moves around the wheel rotation axis, a center of mass of the first weight follows a first path defined by the weight guiding arrangement, wherein the first path exhibits a first portion with a first radius of curvature, and a second portion with a second radius of curvature, larger than the first radius of curvature;
wherein the traction control system is controllable to be coupled to the wheel in such a way that the at least first weight of the traction control system moves around the wheel rotation axis.

11. The vehicle of claim 10, wherein the first path defined by the weight guiding arrangement comprised in the traction control system exhibits the second radius of curvature between the wheel rotation axis and the contact surface, and exhibits the first radius of curvature further away from the contact surface than the wheel rotation axis.

12. The vehicle of claim 10, wherein the vehicle comprises a coupling controllable to couple the traction control system to the wheel in such a way that the at least first weight moves around the wheel rotation axis in response to rotation of the wheel around the wheel rotation axis.

13. The vehicle of claim 12, wherein:
the vehicle further comprises a braking system operable to apply a retardation torque to the wheel in response to a braking request; and
the coupling is configured to couple the traction control system to the wheel in response to the braking request.

14. The vehicle of claim 10, further comprising a processor configured to:
receive a braking request; and
control the coupling to couple the traction control system to the wheel in response to the braking request.
